(19) United States
(12) Patent Application Publication
(10) Pub. No.: US 2021/0169147 A1
(43) Pub. Date: Jun. 10, 2021

(54) Multi-Stage Draw Indication System for a Vaporization Device

(71) Applicant: 14th Round Incorporated, Los Angeles, CA (US)

(72) Inventors: Jeremy GREEN, Pacific Palisades, CA (US); Alex Clulee, Algester (AU)

(21) Appl. No.: 16/707,919

(22) Filed: Dec. 9, 2019

(51) Int. Cl. A24F 40/53; A24F 40/90; A24F 40/51; F21V 23/04

(52) U.S. Cl. CPC A24F 40/53; A24F 40/90; F21W 2111/00; F21V 23/0442; A24F 40/51

(57) ABSTRACT

A vaporization device comprises a body, a plurality of illuminating indicators disposed within or on the body and visible from outside the body, and control circuitry disposed within the body. The control circuitry operatively connects one or more of the plurality of illuminating indicators with a power source disposed within the body to illuminate the one or more of the plurality of illuminating indicators in a sequence in response to a predetermined event.

### FIELD OF THE INVENTION

The present invention relates to a vaporization device or atomizer. More specifically, the present invention relates to a vaporization device or atomizer having a set of indicators that illuminate upon inhalation by a user.

### BACKGROUND

Vaporization devices, also known as electronic cigarettes or e-cigarettes, having a light source visible to a user when the device is operating are known in the prior art. For example, Liu, U.S. Pat. No. 9,949,510 discloses a lamp assembly comprised of one or more light-emitting diode (LED) lights, where the lamp assembly is disclosed to function as an indication to alert a user that an atomizer assembly is on.

In another example, Alarcon, et al., U.S. Pat. No. 10,143,241 discloses a plurality of LEDs having an intensity of illumination that is dependent upon a user's draw strength. The intensity of each of the plurality of LEDs can also be individually varied to create a smoldering effect to mimic a conventional cigarette.

In another prior art example, Bowen, U.S. Pat. No. 10,231,486 discloses a vaporization device having an entertainment or game mode that comprises illumination of a plurality of LEDs comprising one or more colors. In one embodiment, a user puts the device into the entertainment mode by “drawing on the device in a particular pattern, duration or frequency.” In another embodiment, the plurality of LEDs illuminates in a pattern dependent upon the orientation of the device.

In yet another example, Leung U.S. Pat. No. 10,334,878 discloses an LED light element that illuminates with an intensity dependent upon the strength of a user's draw. To indicate dosage, battery level, and other parameters, the LED light element displays various colors and flashing sequences. It can be useful to a user of a vaporization device to know the length of their draws on the device. However, the prior art does not disclose a system for indicating the length of a draw to a user. Therefore, a need exists for a multi-stage indicator of a user's draw on a vaporization device. A visual indication, for example, one or more lights that illuminate in a sequence or pattern of illumination in response to the length of a user's draw is an effective way to indicate the length of the user's draw to the user.

### SUMMARY OF THE INVENTION

According to one aspect of the invention, a vaporization device comprises a body, a plurality of illuminating indicators disposed within or on the body and visible from outside the body, and control circuitry disposed within the body. The control circuitry operatively connects one or more of the plurality of illuminating indicators with a power source disposed within the body to illuminate the one or more of the plurality of illuminating indicators in a sequence in response to a predetermined event.

According to another aspect of the invention, a vaporization device comprises a body having an airflow aperture disposed through an exterior surface of the body, a plurality of illuminating indicators disposed within or on the body and visible from outside the body, and a sensor disposed within the device in fluid communication with the airflow aperture. Control circuitry disposed within the device is operatively connected to the sensor, a power source disposed within the body, and the plurality of illuminating indicators. The control circuitry provides one or more of the plurality of illuminating indicators with power from the power source to illuminate the one or more of the plurality of illuminating indicators in a sequence in response to a draw on the airflow aperture.

According to a further aspect of the invention, a draw indicator for a vaporization device comprises a plurality of illuminating indicators disposed within or on the vaporization device and visible at an exterior surface of the device. An airflow aperture is disposed through an exterior surface of the device. A sensor is disposed within the device in fluid communication with the airflow aperture. Control circuitry is disposed within the device, wherein the control circuitry is operatively connected to the sensor, a power source disposed within the body, and the plurality of illuminating indicators. The control circuitry provides one or more of the plurality of illuminating indicators with power from the power source to illuminate the one or more of the plurality of illuminating indicators in a sequence in response to a draw on the airflow aperture.

### BRIEF DESCRIPTION OF THE DRAWINGS

FIG. 1 is a perspective view of an embodiment of the vaporization device;

FIG. 2 is an exploded perspective view of an embodiment of the vaporization device;

FIG. 3 is an enlarged exploded perspective view of a portion of an embodiment of the vaporization device illustrating the plurality of illuminating indicators; and

FIG. 3A is an enlarged exploded perspective view of a portion of an embodiment of the vaporization device illustrating further illustrating internal components.

Other aspects and advantages of the present invention will become apparent upon consideration of the following detailed description, wherein similar structures have similar reference numerals.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

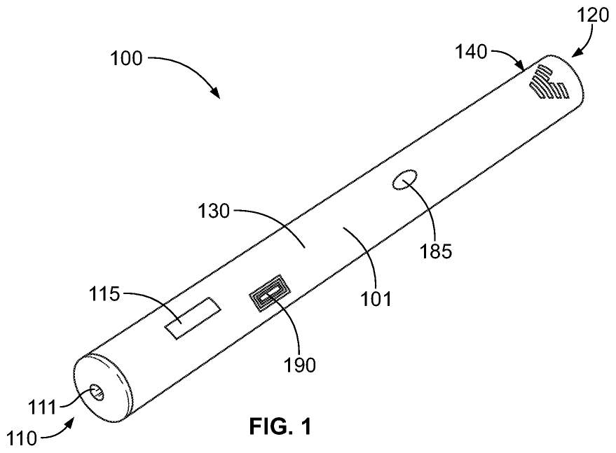

Referring to FIG. 1, an embodiment of vaporization device 100 has an elongate body 101, having a first end 110, a second end 120, and a side surface 130. In one embodiment the vaporization device 100 has a cylindrical elongate body 101 having a circular cross-section, so there is one continuous side surface 130. In other embodiments the elongate body 101 may have other cross sections, for example without limitation, a triangular cross-section, a rectangular cross-section, a pentagonal cross-section, a hexagonal cross-section, or any other regular or irregular polygonal cross-section, and so may have 3, 4, 5, 6, or more side surfaces 130.

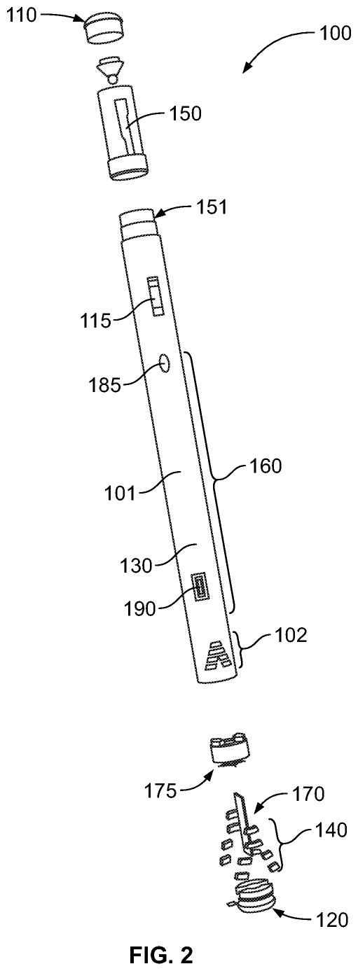

In one embodiment the vaporization device 100 has an airflow aperture 111 disposed through an exterior surface of the body 101, for example, through the first end 110 thereof. In other embodiments the airflow aperture 111 is disposed through the exterior surface of the body 101 at other positions on the body 101. In one embodiment a window 115 is disposed on the side surface 130 to provide visual access to the contents of an electronic vaporizing liquid (e-liquid) tank or reservoir 150 (see FIG. 2) disposed within the elongate body 101.

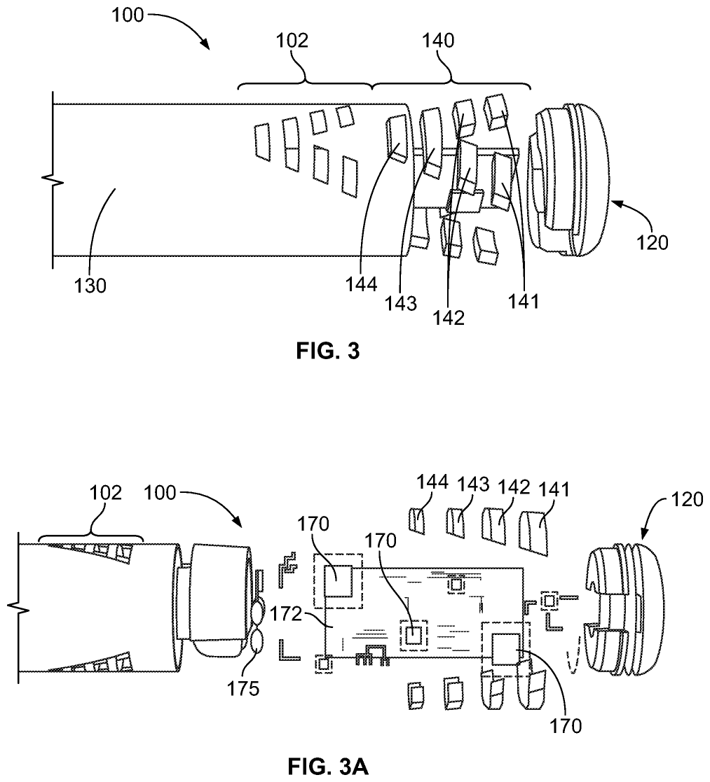

The vaporization device 100 includes a visual indicator 140. For example, in one embodiment the visual indicator comprises a plurality of illuminating indicators 140. In one embodiment the plurality of illuminating indicators 140 (described in further detail below with regard to FIGS. 2, 3, and 3A) is positioned to be visible from outside of the body 101, for example, on the side surface 130. In another embodiment the plurality of illuminating indicators 140 is visible from outside of the body, for example, through a plurality of openings 102 (see FIGS. 2, 3, and 3A) disposed through the side surface 130.

Referring to FIG. 2, an exploded view of the vaporization device illustrates internal components thereof. For example, in one embodiment the e-liquid reservoir 150 is disposed near the first end 110. In one embodiment a heating element or heating coil 151 detachably connects with an end of the e-liquid reservoir 150. In other embodiments the e-liquid reservoir 150 and the heating coil 151 are integral components of an assembly that do not detach. Regardless of whether the connection between the e-liquid reservoir 150 and the heating coil 151 is detachable or not, as known in the art e-liquid from the e-liquid reservoir 150 is supplied to the heating coil 151 by a wick or other porous material (not shown).

As known in the art, the wick or other porous material (not shown) contacts and transports the e-liquid by capillary action from the e-liquid reservoir 150 to the heating coil 151. In some embodiments the wick or other porous material (not shown) contacts the heating coil 151 but in other embodiments the wick or other porous material (not shown) does not contact the heating coil 151, but is disposed, for example, within or in proximity to the heating coil 151. Regardless of the relative geometry of the heating coil 151 to the wick or other porous material (not shown), the heating coil 151 produces sufficient heat to vaporize the e-liquid delivered thereto from the e-liquid reservoir 150 for ultimate inhalation by a user.

In one embodiment the vaporization device 100 includes a power source 160 within the body 101. For example, in one embodiment the power source 160 comprises a battery 160 disposed inside the elongate body 101 positioned between the e-liquid reservoir 150 and the second end 120 as indicated schematically by the brackets in FIG. 2. The battery 160 may be a rechargeable or single use battery or battery pack of any composition as may be known in the art.

Referring to FIGS. 2 and 3A, control circuitry 170 and a sensor 175 are operatively connected and disposed within the body 101 near the second end 120. The control circuitry 170 is operatively connected to the power source 160, and the plurality of illuminating indicators 140, as well as to other components within the vaporization device. An operative connection to the control circuitry comprises, for example, an electrical connection via one or more of wires, traces, or other conductive paths disposed within independent structures, including for example without limitation switches, or disposed through or on the body 101, or otherwise as known in the art, and/or a telecommunicative connection via a transmitter and a receiver disposed in sending and receiving components, respectively.

In one embodiment as illustrated in FIG. 3A the control circuitry 170 comprises a printed circuit board 172 with one or more electronic components disposed thereon as may be known in the art. In other embodiments, the control circuitry comprises one or more microprocessors, microchips, microcontrollers, programmable chips, or other control devices alone or in combination with a printed circuit board 172 as may be known in the art. In one embodiment the sensor 175 comprises a pressure sensor. In other embodiments the sensor 175 comprises, for example without limitation, a gas flow sensor, an optical sensor, or another sensor capable of sensing a drop in pressure or a flow of gas around it.

As is known in the art, the control circuitry 170 electrically connects the power source 160, the heating coil 151, and the sensor 175. The sensor 175 is further disposed within a portion of the body 101 that is in fluid communication with the airflow aperture 111. In operation, when a user provides a suction or vacuum on the airflow aperture 111, where such suction or vacuum is commonly referred to as a draw, the sensor 175 detects the draw, for example without limitation, by one or more of a resultant drop in pressure or a flow of gas thereby. The sensor 175 signals detection of the draw, for example without limitation, by a change in output voltage, to the control circuitry 170, which in response to the signal activates the heating coil 151 by connecting it to the power source 160 to vaporize e-liquid for inhalation by the user. In addition to activating the heating coil 151, in the current invention the control circuitry 170 also provides one or more of the plurality of illuminating indicators 140 with power from the power source 160 to activate the one or more of the plurality of illuminating indicators 140 as is further described hereinbelow.

Referring to FIGS. 3 and 3A, the plurality of illuminating indicators 140 are illustrated exploded out of the vaporization device 100 near the second end 120. In one embodiment the plurality of illuminating indicators 140 are light emitting diodes (LEDs). In other embodiments the plurality of illuminating indicators comprises, for example without limitation, liquid crystals (LCDs), incandescent lights, or other lights as may be known in the art. In one embodiment the plurality of illuminating indicators 140 comprises a plurality of different colors, for example without limitation, yellow, red, green, blue, orange, pink, brown, black, or other colors. In another embodiment the plurality of illuminating indicators comprises a single color.

In one exemplary embodiment the plurality of illuminating indicators 140 is configured in a V-shape as visible in FIG. 3. In this embodiment, the exemplary V-shaped configuration is provided on two opposite sides of the side surface 130, but in other embodiments the V-shaped configuration is provided at only one location on the side surface 130. Each of the V-shaped configurations includes a first pair of illuminating indicators 141 having a first color, a second pair of illuminating indicators 142 having a second color, a first single illuminating indicator 143 having a third color, and a second single illuminating indicator 144 having a fourth color. In other embodiments, the plurality of illuminating indicators comprises other configurations, including for example without limitation, one or more alphanumeric characters, one or more symbols, one or more geometric shapes, one or more lines, one or more curves, and combinations of any two or more of the above listed configurations.

In the exemplary embodiment illustrated in FIGS. 3 and 3A the plurality of illuminating indicators 140 is visible through the plurality of openings 102 disposed through the side surface 130. In other embodiments the plurality of illuminating indicators 140 is disposed on the side surface 130. Independent of where the plurality of illuminating indicators 140 is disposed, the control circuitry 170 electrically and operatively connects the plurality of illuminating indicators 140 with the power source 160.

In operation the plurality of illuminating indicators 140 provides an indication of the occurrence of a predetermined event. For example, in one embodiment the predetermined event is that a user is drawing on the airflow aperture 111. In another embodiment, the predetermined event is that a user has stopped drawing on the airflow aperture 111, or alternatively, an end of the predetermined event is when the user has stopped drawing on the airflow aperture 111.

In another embodiment, the predetermined event is the pressing of a switch or pushbutton, for example without limitation, pushbutton 185 disposed anywhere on the vaporization device 100, and illustrated in different positions in FIGS. 1 and 2. In this embodiment the pushbutton 185 is electrically connected to the control circuitry 170 so that pressing on the pushbutton 185 closes a switch that is connected with the control circuitry 170 and triggers an indication of the occurrence of the predetermined event.

In a further embodiment, the predetermined event is the connection of the vaporization device 100 to a charger (not shown) for the purpose of recharging the power source 160, for example, a rechargeable battery 160. The connection to the charger may be via a wired connection or an unwired connection utilizing inductive charging of the power source 160. In the case of a wired connection, a jack or plug 190 is disposed anywhere on the vaporization device 100, and illustrated in different positions in FIGS. 1 and 2. The jack or plug 190 can be any suitable male or female plug or plug receptacle as known in the art, for example without limitation, a USB port, a micro-USB port, a simple pair of contacts, or the like. The jack or plug 190 is electrically connected to the control circuitry 170 so that connection of the jack or plug 190 with an external source of power triggers an indication of the occurrence of the predetermined event. In the case of a wireless connection, internal structure (not shown) as known in the art and electrically connected with the control circuitry 170 charges the power source 160 when the vaporization device 100 is placed on an inductive charging surface, for example without limitation, a charging pad or plate (not shown). The start of inductive charging resulting from the vaporization device 100 being placed on the charging pad or plate triggers an indication of the occurrence of the predetermined event.

In one embodiment, the indication that a predetermined event has occurred comprises a visual indication. In one embodiment the visual indication comprises one or more of the plurality of illuminating indicators 140 illuminating steadily for a predetermined time. In another embodiment the visual indication comprises a flashing of one or more of the plurality of illuminating indicators 140, where each flash comprises a predetermined period of illumination followed by a predetermined period of no illumination.

In another embodiment, a visual indication comprises a sequence or pattern of illumination where, for example, a first one or more of the plurality of illuminating indicators 140 illuminates or flashes and is followed after a first predetermined time period by a second one or more of the plurality of illuminating indicators 140 illuminating or flashing. The first one or more of the plurality of illuminating indicators 140 remains illuminated or continues to flash in this embodiment; however, in other embodiments upon illumination of the second one or more of the plurality of illuminating indicators 140 the first one or more of the plurality of illuminating indicators is turned off. In some embodiments, a third one or more of the plurality of illuminating indicators 140 illuminates or flashes after a second predetermined time period. The first and second one or more of the plurality of illuminating indicators 140 remain illuminated or continue to flash in one embodiment; however, in other embodiments upon illumination of the third one or more of the plurality of illuminating indicators 140 the first and/or the second one or more of the plurality of illuminating indicators is turned off.

In other embodiments the sequence of illuminations can continue to a fourth one or more of the plurality of illuminating indicators 140 illuminating or flashing after a third predetermined time period, and to a fifth one or more of the plurality of illuminating indicators 140 illuminating or flashing after a fourth predetermined time period, and so on, for as many of the plurality of illuminating indicators 140 that exist. After each new illumination in the sequence, one or more of the prior one or more illuminated indicators 140 can remain illuminated or continue flashing or can be turned off. After a last one or more of the plurality of illuminating indicators 140 is illuminated or flashes for a last predetermined time period, one or more of the plurality of illuminating indicators are turned off.

In other embodiments the indication that a predetermined event has occurred comprises a combination of two or more visual indications, for example without limitation, as described above. Any of the predetermined time periods for illumination can comprise any length of time as needed to achieve any desired visual effect, for example without limitation, any predetermined time period for illumination can be as short as about 0.00001 second or as long as about 60 minutes.

In addition, in an embodiment having one or more of the plurality of illuminating indicators 140 flashing, flashes are defined as sequentially repeating cycles consisting of a period of flash illumination followed by a period of no illumination. Any of the periods of flash illumination and no illumination for a flashing indicator can comprise any lengths of time as needed to achieve any desired visual effect. For example without limitation, any predetermined time period of flash illumination for any flashing indicator can be as short as about 0.00001 second or as long as about 60 minutes. Further, for example without limitation, any predetermined time period of no illumination for any flashing indicator can be as short as about 0.00001 second or as long as about 60 minutes.

Given that one exemplary predetermined event comprises a user's draw on the airflow aperture 111, the predetermined periods for illumination or flash illumination (or for no illumination) in one embodiment generally correspond to the length of the user's draw. For example, in one embodiment any predetermined time period for illumination or flash illumination (or for no illumination) can range between about 0.0001 second and about 60 seconds. In another embodiment any predetermined time period for illumination or flash illumination (or for no illumination) can range between about 0.001 second and about 10 seconds. In a further embodiment any predetermined time period for illumination or flash illumination (or for no illumination) can range between about 0.01 second and about 5 seconds, or between about 0.01 second and about 1 second.

In another embodiment any of the predetermined time periods for illumination, flash illumination, or no illumination except for the last predetermined time period in a sequence can be in a range between about 0.00001 second and about 30 seconds, and the last predetermined time period in the sequence can be in a range between about 0.00001 second and about 60 seconds.

Applicable to any of the embodiments for any of the sequences of visual indications described herein, if the predetermined event is continuing, for example, if a user is still drawing on the airflow aperture 111, all of the plurality of illuminating indicators 140 that are illuminated or flashing at that point remain illuminated or flashing until the predetermined event stops, for example, until the user stops drawing on the airflow aperture 111, at which time all of the illuminating indicators 140 are turned off.

For example, referring to FIG. 3, in one embodiment upon the draw of a user upon the airflow aperture 111 the sensor 175 detects the draw and signals detection of the draw as is known in the art to the control circuitry 170, which in response to the signal activates the heating coil 151 and also activates the illuminating indicators 140 to provide an indication that the user is drawing on the airflow aperture 111. Still referring to FIG. 3, in this embodiment an exemplary indication begins with the first pair of illuminating indicators 141 illuminating in a first color, for example, yellow.

After a first predetermined time period, for example, 0.75 second, the second pair of illuminating indicators 142 illuminates in a second color, for example, red, while the first pair of illuminating indicators 141 remains illuminated. In other embodiments upon illumination of the second pair of illuminating indicators 142 the first pair of illuminating indicators 141 is turned off. In other embodiments, if the draw of the user stops before passage of the first predetermined time period, then the first pair of illuminating indicators 141 turn off when the draw stops, so that the second pair of illuminating indicators 142 do not illuminate.

Still referring to FIG. 3, in this embodiment after a second predetermined time period, for example, 0.75 second, the first single illuminating indicator 143 illuminates a third color, for example, green, while the first and second pairs of illuminating indicators 141, 142 remain illuminated. In other embodiments, upon illumination of the first single illuminating indicator 143 the first and second pairs of illuminating indicators 141, 142 are turned off. In other embodiments, if the draw of the user stops before passage of the second predetermined time period, then the first and second pairs of illuminating indicators 141 and 142 turn off when the draw stops, so that the first single illuminating indicator 143 does not illuminate.

Still referring to FIG. 3, in this embodiment after a third predetermined time period, for example, 0.75 second, the second single illuminating indicator 144 illuminates a fourth color, for example, blue, while the first and second pairs of illuminating indicators 141, 142, and the first single illuminating indicator 143 remain illuminated. In other embodiments, upon illumination of the second single illuminating indicator 144 the first and second pairs of illuminating indicators 141, 142, and the first single illuminating indicator 143 are turned off. In other embodiments, if the draw of the user stops before passage of the third predetermined time period, then the first and second pairs of illuminating indicators 141 and 142, and the first single illuminating indicator 143 turn off when the draw stops, so that the second single illuminating indicator 144 does not illuminate.

In one embodiment, after illumination of the second single illuminating indicator 144, which is the last of the one or more of the plurality of illuminating indicators 140 being illuminated in this visual indication sequence, all of the plurality of illuminating indicators 140 remain illuminated for a fourth predetermined time period, for example, 2.75 seconds, after which all of the illuminating indicators 140 are turned off. In another embodiment, if the user is still drawing on the airflow aperture 111 after the third predetermined time period has passed, all of the plurality of illuminating indicators 140 remain illuminated until the user stops drawing on the airflow aperture 111, at which time all of the illuminating indicators 140 are turned off.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### INDUSTRIAL APPLICABILITY

A vaporization device is provided with a draw indicator that provides an indication of a user's length of draw on the device. The draw indicator comprises a plurality of illuminating indicators disposed within or on the vaporization device and visible at an exterior surface of the device. Control circuitry disposed within the device receives a signal from a sensor indicating a user's draw. In response to the signal the control circuitry provides one or more of the plurality of illuminating indicators with power from a power source within the device to illuminate the one or more of the plurality of illuminating indicators in a sequence. The vaporization device can be manufactured in industry for use by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

1. A vaporization device, comprising:
a body;
a plurality of illuminating indicators disposed within or on the body and visible from outside the body whether illuminated or not; and
control circuitry disposed within the body; wherein
the control circuitry operatively connects the plurality of illuminating indicators with a power source disposed within the body to illuminate a number of the plurality of illuminating indicators in a sequence wherein the number of illuminated indicators provides an indication of the length of a draw on the vaporization device.

2. The vaporization device of claim 1, wherein the plurality of illuminating indicators is visible from outside the body through a plurality of openings disposed through a surface of the body.

3. The vaporization device of claim 1, further comprising:
an airflow aperture disposed through an exterior surface of the body;
wherein the draw on the vaporization device comprises a draw on the airflow aperture.

4. (canceled)

5. The vaporization device of claim 1, wherein the sequence comprises:
illuminating a first one or more of the plurality of illuminating indicators for a first predetermined time period or until the draw ends; and
subsequent to the first predetermined time period, if the draw is continuing, illuminating a second one or more of the plurality of illuminating indicators for a second predetermined time period or until the draw ends.

6. The vaporization device of claim 1, wherein the sequence further comprises:
subsequent to the second predetermined time period, if the draw is continuing, illuminating a third one or more of the plurality of illuminating indicators for a third predetermined time period or until the draw ends.

7. The vaporization device of claim 6, wherein the sequence further comprises:
subsequent to the third predetermined time period, if the draw is continuing, illuminating a fourth one or more of the plurality of illuminating indicators for a fourth predetermined time period or until the draw ends.

8. The vaporization device of claim 7, wherein
the first predetermined time period is in a range from about 0.001 second to about 60 minutes;
the second predetermined time period is in a range from about 0.001 second to about 60 minutes;
the third predetermined time period is in a range from about 0.001 second to about 60 minutes; and
the fourth predetermined time period is in a range from about 0.001 second to about 60 minutes.

9. The vaporization device of claim 7, wherein any of the first, second, third, and fourth one or more of the plurality of illuminating indicators that illuminate during the sequence remains illuminated through passage of the fourth predetermined time period or until the draw ends.

10. A vaporization device, comprising:
a body having an airflow aperture disposed through an exterior surface of the body;
a plurality of illuminating indicators disposed within or on the body and visible from outside the body whether illuminated or not;
a sensor disposed within the device in fluid communication with the airflow aperture; and
control circuitry disposed within the device; wherein
the control circuitry is operatively connected to the sensor, a power source disposed within the body, and the plurality of illuminating indicators; and wherein
the control circuitry provides the plurality of illuminating indicators with power from the power source to illuminate a number of the plurality of illuminating indicators in a sequence, wherein the number of illuminated indicators provides an indication of the length of a draw on the airflow aperture.

11. The vaporization device of claim 10, wherein the sequence comprises:
illuminating a first one or more of the plurality of illuminating indicators for a first predetermined time period or until the draw on the airflow aperture ends; and
subsequent to the first predetermined time period, if the draw on the airflow aperture is continuing, illuminating a second one or more of the plurality of illuminating indicators for a second predetermined time period or until the draw on the airflow aperture ends.

12. The vaporization device of claim 11, wherein the sequence further comprises:
subsequent to the second predetermined time period, if the draw on the airflow aperture is continuing, illuminating a third one or more of the plurality of illuminating indicators for a third predetermined time period or until the draw on the airflow aperture ends.

13. The vaporization device of claim 12, wherein the sequence further comprises:
subsequent to the third predetermined time period, if the draw on the airflow aperture is continuing, illuminating a fourth one or more of the plurality of illuminating indicators for a fourth predetermined time period or until the draw on the airflow aperture ends.

14. The vaporization device of claim 13, wherein any of the first, second, third, and fourth one or more of the plurality of illuminating indicators that illuminate during the sequence remains illuminated through passage of the fourth predetermined time period or until the draw on the airflow aperture ends.

15. The vaporization device of claim 14, wherein
the first predetermined time period is in a range from about 0.001 second to about 1 second;
the second predetermined time period is in a range from about 0.001 second to about 1 second;
the third predetermined time period is in a range from about 0.001 second to about 1 second; and
the fourth predetermined time period is in a range from about 0.001 second to about 5 seconds.

16. A draw indication system for a vaporization device, comprising:
a plurality of illuminating indicators disposed within or on the vaporization device and visible at an exterior surface of the device whether illuminated or not;
an airflow aperture disposed through an exterior surface of the device;
a sensor disposed within the device in fluid communication with the airflow aperture; and
control circuitry disposed within the device; wherein
the control circuitry is operatively connected to the sensor, a power source disposed within the body, and the plurality of illuminating indicators; and wherein
the control circuitry provides the plurality of illuminating indicators with power from the power source to illuminate a number of the plurality of illuminating indicators in a sequence wherein the number of illuminated indicators provides an indication of the length of a draw on the airflow aperture.

17. The draw indication system of claim 14, wherein the sequence comprises:
illuminating a first one or more of the plurality of illuminating indicators for a first predetermined time period or until the draw on the airflow aperture ends;
subsequent to the first predetermined time period, if the draw on the airflow aperture is continuing, illuminating a second one or more of the plurality of illuminating indicators for a second predetermined time period or until the draw on the airflow aperture ends;
subsequent to the second predetermined time period, if the draw on the airflow aperture is continuing, illuminating a third one or more of the plurality of illuminating indicators for a third predetermined time period or until the draw on the airflow aperture ends; and
subsequent to the third predetermined time period, if the draw on the airflow aperture is continuing, illuminating a fourth one or more of the plurality of illuminating indicators for a fourth predetermined time period or until the draw on the airflow aperture ends.

18. The draw indication system of claim 17, wherein
the first predetermined time period is in a range from about 0.001 second to about 1 second;
the second predetermined time period is in a range from about 0.001 second to about 1 second;
the third predetermined time period is in a range from about 0.001 second to about 1 second; and
the fourth predetermined time period is in a range from about 0.001 second to about 5 seconds.

19. The draw indication system of claim 17, wherein each of the first, second, third, and fourth one or more of the plurality of illuminating indicators illuminates in a different color.

20. The draw indication system of claim 17, wherein
the plurality of illuminating indicators is configured in a V-shaped configuration comprising: the first one or more of the plurality of illuminating indicators comprising a first pair of illuminating indicators, one on each side of an open end of the V-shaped configuration;
the second one or more of the plurality of illuminating indicators comprising a second pair of illuminating indicators, one on each side the V-shaped configuration and adjacent to each of the first pair of illuminating indicators;
the third one or more of the plurality of illuminating indicators comprising a single illuminating indicator adjacent to the second pair of illuminating indicators; and
the fourth one or more of the plurality of illuminating indicators comprising a single illuminating indicator at a closed end of the V-shaped configuration.
